(19) United States
(12) Patent Application Publication
(10) Pub. No.: US 2004/0251304 A1
(43) Pub. Date: Dec. 16, 2004

(54) System and method for monitoring, controlling and reporting access and attendance behavior

(75) Inventors: Avi Carmon, Ramat Hasharon (IL); Ilan Lilien, Kefar Saba (IL); Avi Schechter, Ramat Gan (IL)

Correspondence Address: BRUCE E. LILLING, LILLING & LILLING P.C., P.O. BOX 560, GOLDEN BRIDGE, NY, 10526, US

(73) Assignee: Supercom Ltd., Ra'anana (IL)

(21) Appl. No.: 10/747,767

(22) Filed: Dec. 29, 2003

(30) Foreign Application Priority Data
Mar. 24, 2003 (IL) 155050

(51) Int. Cl. G06K 5/00

(52) U.S. Cl. 235/382

(57) ABSTRACT

The system monitors and controls access and attendance of individuals, and includes an identification means for each individual which are characteristic to said individual; a mobile data collection unit for reading and storing the identification means and transferring it to the controller, a management computer; a first relay system to transmit data regarding an individual from the data collection unit to the management computer; and, a second relay system to transmit data regarding an individual to a remote client.

### SUMMARY OF THE INVENTION

The present invention provides a system for monitoring and controlling access and attendance of individuals comprising of:

1) an identification means for each individual which are characteristic to said individual;

2) a mobile data collection unit (hereinafter “DCU”) comprising a controller, one or more readers capable of reading said identification means and transferring it to the controller, a power source, and a data management software (hereinafter “Data Manager”) residing on said controller which receives, stores, updates, processes and outputs data regarding each individual;

3) a management computer;

4) SW Application useful in access control, attendance control or a combination thereof, residing on said management computer

5) a first relay system (hereinafter “Mobile Relay”) may be employed to transmit data regarding an individual from the DCU to the management computer

6) a second relay system (hereinafter “Relay”) may be employed to transmit data regarding an individual from said access control application to a remote client;

7) Individuals data manager used for individuals enrolment to the system, creation of the access control database and database for the manufacturing of the IDUs

### BRIEF DESCRIPTIONS OF THE DRAWING

FIG. 1 Represents an illustrative scheme of an “off-line” embodiment of the system.

FIG. 2 Represents an illustrative scheme of an “on-line” embodiment of the system.

FIG. 3 Represents a particular embodiment of the present invention.

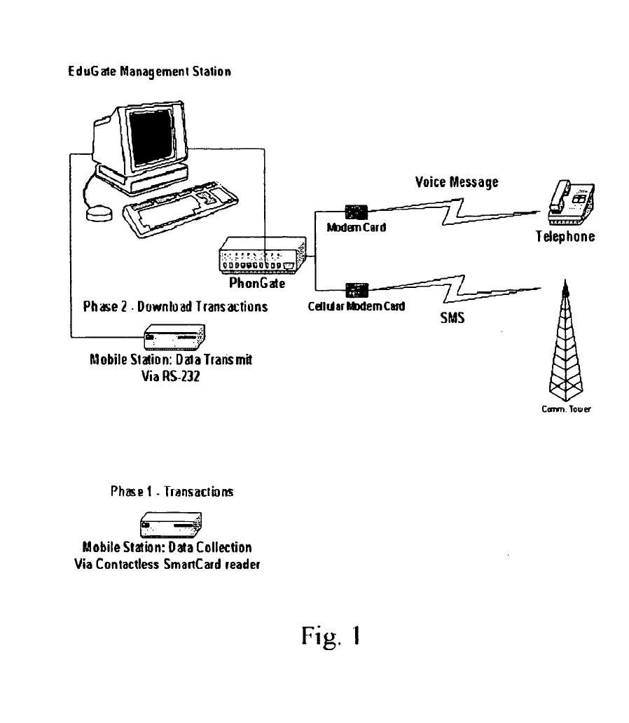

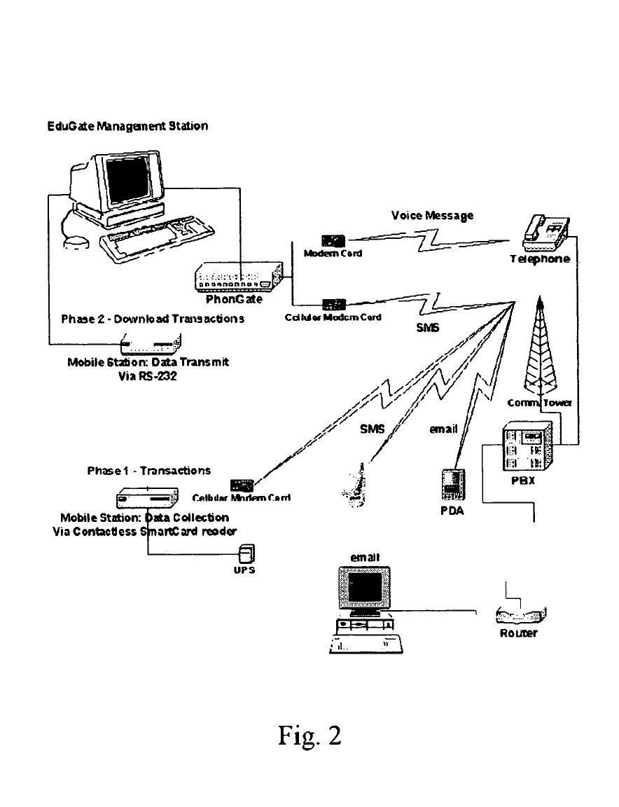

### DETAILED DESCRIPTION OF PREFERRED EMBODIMENTS

The following description is illustrative of embodiments of the invention. The following description is not to be construed as limiting, it being understood that the skilled person may carry out many obvious variations to the invention.

According to the present invention there is provided a system for monitoring and controlling attendance of individuals, wherein said system comprises of:

1) an identification means (hereinafter “IDM”) for each individual which are characteristic to said individual;

The IDM may be of various types, some of which are already known. These can be inherent biometric features e.g. fingerprints, hand dimensions, eye characteristics, voice, face, and/or an external means e.g. magnetic cards, optically readable cards (bar codes, magnetic stripe), cards with electronic data transfer capability, cards equipped with memory chips or microcomputer known as smartcards electronic chips, microchips, or combinations thereof.

According to another embodiment, the information recorded by the IDM is recorded by a person, other than said individual. According to this embodiment, the IDM is not necessarily recordation of identifying features of the individual.

According to another embodiment, the information recorded by the IDM is of the nature of the behavior of the individual, and is recorded by a person, other than said individual.

2) A mobile data collection unit (hereinafter “DCU”):

The Reader of the present invention comprises one or more means for reading the identification means, e.g. biometric readers (fingerprint, hand, eye, voice, face) bar code scanner, Contact or Contactless smartcard reader, RFID readers magnetic stripe readers or combinations thereof, and storage and processing capabilities enabling it to record transactions of approved and non approved IDM's brought to the proper distance or contact with the Reader/s.

The DCU is capable of connecting to the management computer; and thus download the updated registered transactions data from the DCU and upload from the management computer; the updated approved (white) list or the non approved (black) list and/or other information that is required when compared to the data exchanged with the reader for confirming the validity of the IDU.

The controller approves or rejects in real time the transactions received from the reader. The approval is by some light signal and/or by buzzer and/or by optionally opening a door. The controller sends the transactions list collected since the last negotiation with the management computer and receives from the access control application (running on the management computer) the updates of white (known but approved) and black (known but not approved) lists. The negotiations with the control computer (with the access control application) may be carried on via network, via LAN, wireless LAN Modem, RS232, RS485 cellular modem, modem ext. Updated individual lists are uploaded and the transactions are downloaded to the computer. This can be repeated with all the DCUs

According to a preferred embodiment, the DCU is a mobile unit comprising of an independent power source, e.g. a battery, preferably a rechargeable battery.

According to another preferred embodiment, Mobile relay connection between the DCU and the management computer is a direct connection.

According to another preferred embodiment, Mobile Relay connection between the DCU and the management computer is a remote and possibly mobile means of communication e.g. via telephone modem, satellite, cable, radio, cellular.

Alternatively the DCU may be connected in the common way to the network or to a dedicated network to exchange data with the management computer.

The controller employed for the purposes of the present invention may be any type of computer capable of supporting the Data Manager, preferably a single board computer.

The Data Manager can comprise of a number of software applications which can be linked. Initially, before activating the system, the Data Manager is loaded with the data of the individuals. The processing capabilities of the Data Manager are customized to the needs of the client of the system, as will be explained herein.

1) a management computer;

2) access control SW Application residing on said management computer

3) a first relay system (hereinafter “Mobile Relay”) may be employed to transmit data regarding an individual from the DCU to the management computer

The Mobile Relay transmits data from the Data Manager via radio or cellular modems to the management station. This is further illustrated in the drawings. The mobile relay system can act as a feedback provider.

The second relay system is designed to automatically report presence or absence to a designated destination (e.g. parents, school administration), remotely add special announcements to said destinations personalized per the individual and get the approval from that destination

According to another embodiment the relay system is designed such that the remote client, (e.g. parents, school administration—if the system is used in a school), can initiate a connection with the host computer in order to retrieve any available desired information. This access is optionally associated with an authentication process of the client.

An important feature of the present invention is the ability to apply it in cases where the organizer of an event such as a conference or exhibition does not own the building or campus and the infrastructure but is obliged to give a complete access solution. Thus the present invention is very useful, in a “one time event”, this without diminishing the possibility of using the present invention in repeatable events when the user prefers not to invest in access control fixed infrastructure.

According to a particular embodiment of the invention the system is a student-attendance-monitoring system in a school, wherein student attendance is monitored by providing each student with a smartcard (=IDM). The system further comprises of a DCU and Data Manager software. The DCU is further used to record student presence.

According to another embodiment, the system consists of the following hardware and software components: mobile Gate that serves as a remote agent, installed at the school gate. As the students pass through the school gate or classroom, they present their smart ID cards (=IDM) in front of the mobile gate (=DCU) reader to register their presence.

Dedicated software application for the initial loading of the student records from the school's student database into the EduGate™ (=Individual Data Manager) database. The pre-loading is done at the manufacturer's premises. EduGate™ holds textual information about the students, such as the student names and telephone numbers, as well as the student photographs and other relevant information.

The EduGate™ Data Manager application for updating and maintaining the local student database, and preparing the necessary data for ID card production and for the Access Control and Attendance application. ID cards are manufactured at the manufacturer's production facility.

The Access Control and Attendance Application controls and registers the students' entry and presence. The application imports the students' data from the EduGate™ Data Manager database and downloads the necessary data to the DynaGate™ (DCU) controller. The application also uploads the transactions recorded on the DynaGate™ DCU back to the Access Control Application. The DynaGate™ remote agent should be frequently updated with the records of all school students.

PhoneGate™—an optional feedback system designed to automatically report presence or absence to a designated destination (school administration, parents). This system resides on the access control management system

As the component overview above indicates, data flows in the system as follows:

1. Students' personal data from the school database goes to the local EduGate™ Data Manager database. Records can also be added/updated manually in this database.

2. Students' personal data from the EduGate™ Data Manager database goes to the ID card production facility and to the EduGate™ DCU.

3. The ID Card production facility returns the manufactured cards and a report including printing statistics as well as a list of the records that could not be produced.

4. Transactions' data from the DynaGate™ DCU is returned back to the access control system.

5. A list of absent/late students is produced by the access control and attendance system and can be used by the optional PhoneGate™ system to automatically place calls to the respective parents or other authorities.

Optionally, absence of a student from school is reported by the Relay via e-mail, voice or SMS message.

The DCU is installed at a location in the school where monitoring is required, e.g., the school gate or entrance to classroom. As the students pass through the school gate or classroom entrance, they present their smart cards in front of the DCU reader to register their attendance. This enables to control the access to the school or classroom and to collect attendance information while students enter the school premises or classroom. At said location the DCU works off-Line independently, on its built-in independent power source. The DCU is subsequently transferred to the school office, to load updated student data, download recorded transactions, and charge the battery.

A dedicated software application for the initial loading of the student records from the school's student database. The Individual Data Manager updates and maintains the local student database, and assists in preparing the necessary data for identification card production, and for the Access Control and Attendance application, which is part of the Data Manager. The Access Control and Attendance Application controls and registers the students' entry and presence. The application imports the students' data from the Individuals Data Manager database and downloads the necessary data to the DCU. The application also uploads the transactions recorded on the DCU back to the Access Control Application. The DCU must be frequently updated with the records of all school students.

The optional Relay is designed to automatically report presence or absence to a designated destination, e.g., school administration and parents. This is a rule based system where each individual may have different rules.

According to another embodiment, the present invention provides a system for controlling the boarding of passengers on an airplane. In a first step, all the passengers are identified at the check-in station. At this point the passengers are provided with a personal means of identification e.g. a personal card with a photo, or one or more of their biometric features are recorded, e.g, fingerprints or hand geometry. In the second step, in order to board the plane, the IDM records the identifying data compared to the preloaded data base on the DCU controller the passenger information are than read by the reader and compared to the preloaded database on the controller and approve or reject the holder of the IDU and thus the system may control the attendance of all the passengers who are intended to board the plane.

According to a preferred embodiment, the present invention is applied in a conference or exhibition wherein the knowledge and control of the presence of the participants or the visitors is needed.

According to a yet further embodiment the present invention is applied in a school bus, thus controlling the entry, presence and departure of students to, in and from said school bus.

While embodiments of the invention have been described by way of illustration, it will be apparent that the invention may be carried out with many modifications, variations and adaptations, without departing from its spirit or exceeding the scope of the claims.

Following is an example of the use of the present invention.

Contactless SmartCard

| | |
|---|---|
| Features: | |
| Chip Type | Contactless memory Up to 4 Kb |
| Special Features | Magnetic stripe Hi-Co (Optional) |
| | Secured data storage |
| | Contactless environment advantage |
| Specifications: | |
| Read Range | 2.5-5.0 cm |
| Transmit | 13.56 MHz ± 5% |
| Frequency | |
| Card Size | ID1 to ID2 and custom sizes |

DynaGate ™
(Reader + Controller)

| | |
|---|---|
| Features: | |
| Connectors | Two connectors for readers |
| | Connector for programming display panel. |
| Memory | 512 K of protected RAM |
| Clock | Protected Real Time date/time clock |
| Backup battery | Backup battery for the memory and Real time clock with cooling |
| | system - charge level: Green to Red indication |
| Case | Water resistant - case and all electrical external facing components |
| | Plastic rugged heavy duty case with optional sealing/locker |
| | Rust free components |
| | Shock absorbent assembly for critical components: Battery, controller, |
| | Readers |
| Specifications: | |
| Communication | RS-232 communication - Port to port configuration |
| | A single terminal, equipped with RS-232 communications, can be |
| | connected directly to an asynchronous RS-232 port. If RS-232 |
| | communication is used, only one terminal may be connected to each |
| | COM port and cabling distances should not exceed 50 meters (160 ft). |
| | RS-485 communication - Multiple terminal configuration |
| | RS-485 communication enables you to connect up to 32 terminals to a |
| | single COM port and/or to extend the cabling distance to up to 1,000 |
| | meters (3,280 feet) using 9600 baud via an RS-485 multi-drop line. RS- |
| | 485 communication uses two wires as opposed to RS-422 |
| | communication, which uses four wires. |
| | Charger input (2 Pin), |
| | Telephone port (RJ-11) 2 pin |
| I/O | Two sensors (door monitoring) |
| | Two relays for bell, door, etc . . . |
| Baud Rate | Variable baud rate - 1200 to 19200 bps |
| Accessories | Short RS-232/485 communication cable |
| | TCP/IP communication cable (option). |
| Power | Voltage: 12 VDC or 115/230 VAC (option). |
| requirements | |
| Physical | Dimensions: 410 × 332 × 175 mm Weight: 6.5-7.5 Kg |
| Characteristics | |
| Operating | Operating temperature: 0° C. to 50° C./32° F. to 122° F. |
| Temperature | Storage temperature: 20° C. to 70° C./6° F. to 158° F. |
| | Operating humidity: 5% to 95% non-condensing |
| Options: | |
| Modem | 2400 bps internal modem |
| | Plug-in internal modem, 2400/1200 bps, with single 5 V operation. The |
| | modem allows communication via external and/or internal telephone |
| | lines (RJ-11). Low power operation, with automatic reduced-power |
| | standby mode. Complies with CCITT V.22bis, V.22, Bell 212 and Bell |
| | 103. FCC Part 68 approved modem. |
| Ethernet | Net connection (Ethernet or Token Ring) |
| | (10BASE-T or AUI) or Token Ring (STP/UTP) |
| Management | Telnet and SNMP management |

Contactless Smart Card Reader

| | |
|---|---|
| Features: | |
| Card | ISO standard compatibility: |
| Compatibility | 14443A - read |
| Data | Reading distance up to 10 cm |
| Communication | |
| Mounting | Screw hole spacing (vertical or horizontal), or to any flat surface. |
| | Reader body snaps onto mounting plate. |
| Display | Indicators (2 LEDs and one optional Buzzer) |
| Indoor/Outdoor | Indoor/outdoor case |
| Case | |
| Security | 64-bit authentication. All RF data transmission between the card and |
| | reader is encrypted, using SAM - a Security Access Module. |
| Specifications: | |

PhoneGate

| | |
|---|---|
| Features: | |
| OS | Freedom of choice: supports Windows* 95, Windows NT* (including |
| | TAPI/WAVE), Windows 2000/XP, MS-DOS*, OS/2*, and UNIX* |
| Advanced call | Enables advanced call processing features for competitive |
| processing | differentiation by supporting software-based features such as Global |
| | DPD; and PBX Expert tone characterization utility |
| Reliability | Ensures reliability via call progress analysis which monitors outgoing |
| | call status quickly and accurately |
| Voice Coding | Offers flexible voice coding at dynamically selectable data rates, 24 to |
| | 64 Kb/s, selectable on a channel-by channel basis for optimal tradeoff |
| | in disk storage and voice quality |
| Voice Quality | Offers superior voice quality through enhanced telephone circuitry and |
| | AGC |
| Network | Satisfy international demands by providing a full suite of international |
| Approvals | telephone network approvals |
| Specifications: | |
| Number of ports | 2 (D/21H) or 4 (D/41H) |
| Host Interface | IBM PC XT/AT (ISA) |
| Telephone | Connector - Two RJ-11 type |
| Interface | Frequency response - 300 Hz to 3400 Hz ± 3 dB (transmit and receive) |
| | Crosstalk coupling - −70 dB at 3 kHz channel-to-channel |
| | Impedance - 600 ohms nominal |
| Power | +5 VDC 500 mA, +12 VDC 35 mA, −12 VDC 35 mA |
| Requirements | Operating temperature −0° C. to + 50° C. |
| | Humidity - 8% to 80% non condensing |
| Regulatory | USA - FCC part 68 ID#: EBZUSA-65588-VM-E, REN: 1.0B,UL: |
| Certifications | E143032 |
| | Canada IC CS-03, 885 4452 A, Load number: 5 ULC: E143032 |

It should be understood that some modification, alteration and substitution is anticipated and expected from those skilled in the art without departing from the teachings of the invention. Accordingly, it is appropriate that the following claims be construed broadly and in a manner consistent with the scope and spirit of the invention.

1) A system for monitoring and controlling access or attendance or a combination of access or attendance of individuals comprising of:
i) an identification means for each individual which are characteristic to said individual;
ii) a mobile data collection unit (hereinafter “DCU”) comprising a controller, one or more readers capable of reading said identification means and transferring it to the controller, a power source, and a data managing software (hereinafter “Data Manager”) residing on said controller which receives, stores, updates, processes and outputs data regarding each individual;
iii) a management computer;
iv) access control SW Application residing on said management computer
v) a first relay system (hereinafter “Mobile Relay”) may be employed to transmit data regarding an individual from the DCU to the management computer
vi) a second relay system (hereinafter “Relay”) may be employed to transmit data regarding an individual from said access control application to a remote client;
vii) Individuals data manager used for individuals enrolment to the system, creation of the access control database and database for the manufacturing of the IDUs

2) A system according to claim 1, in which the identification means is selected from the group that consists of biometric features, fingerprints, hand dimensions, eye characteristics, voice characteristics, face characteristics, body-external means, magnetic cards, optically readable cards, bar codes, magnetic stripe, cards with electronic data transfer capability, cards equipped with memory chips or microcomputer known as smartcards electronic chips, or combinations thereof.

3) A system according to claim 1, in which the reader in the mobile data collection unit is a reader selected from the group that consists of biometric readers, fingerprint readers, hand dimension reader, eye reader, voice reader, face reader, bar code scanner, Contactless smartcard reader, RFID readers magnetic stripe readers or combinations thereof.

4) A system according to claim 1, in which the DCU is a mobile unit comprising of an independent power source.

5) A system according to claim 1, in which the mobile relay connection between the DCU and the management computer is selected from a group that consists of remote means of communication, mobile means of communication, telephone modem, satellite, cable, radio, cellular, wireless LAN, and direct cable connection,

6) A system according to claim 1, in which the controller employed for the purposes of the present invention is selected from a group that consists of a computer capable of supporting the Data Manager and the communication between it and the reader and the management computer.

7) A system according to claim 1 in which the management computer is a single board computer.

8) A system according to claim 1, in which said system is a student-attendance-monitoring system in a school.

9) A system according to claim 1, in which said system is designed for controlling the boarding of passengers on an airplane.

10) A system according to claim 1, in which said system is designed for a conference or exhibition wherein the knowledge and control of the presence of the participants or the visitors is needed.

11) A system according to claim 1, in which said system is applied in a school bus, thus controlling the entry, presence and departure of students to, in and from said school bus.
